(19) United States
(12) Patent Application Publication
(10) Pub. No.: US 2026/0001647 A1
(43) Pub. Date: Jan. 1, 2026

(54) AEROSPACE SYSTEM AND METHOD FOR DELIVERING PAYLOAD TO ORBIT AND TO MIDAIR

(71) Applicant: Michael Yavilevich, Kiriat Bialik (IL)

(72) Inventor: Michael Yavilevich, Kiriat Bialik (IL)

(21) Appl. No.: 18/879,900

(22) PCT Filed: Jun. 14, 2023
(86) PCT No.: PCT/IL2023/050616

§ 371 Date: Dec. 30, 2024

Related U.S. Application Data
(60) Provisional application No. 63/367,917, filed on Jul. 8, 2022.

(51) Int. Cl. B64D 5/00; B64C 30/00; B64C 39/02; B64D 3/00

(52) U.S. Cl. CPC B64D 5/00; B64C 30/00; B64C 39/022; B64D 3/00

(57) ABSTRACT

Combined aerospace system is a multi-stage technology to deliver payloads to orbit and to midair. The system comprises a carrier aircraft, a tow aircraft, a towed spaceplane or a rocket plane or a glider. The carrier aircraft, coupled with the spaceplane and/or the rocket plane or several gliders, takeoff from a runway and ascends to a staging altitude and speed under the carrier aircraft power. After staging, the tow aircraft will pick up the spaceplane or the rocket plane or the glider from the carrier aircraft in flight. The towed spaceplane or the rocket plane or the glider continues ascending and accelerating by the tow aircraft. The spaceplane or the rocket plane will disconnect from the tow aircraft and continue to ascend and accelerate in an atmosphere by using the ramjet engine. The spaceplane or the rocket plane equipped with a propulsion unit is used to place the spacecraft into the earth orbit. The glider will disconnect from the tow aircraft and lands in designated place. Gliders can be used for instantly delivering of correspondence, parcels, and civil goods from a supplier to wide variety of individual consumers or corporate customers.

This application claims the benefit of provisional application: app. Ser. No. 63/367,917 Filing date: Jul. 8, 2022, Applicant: Michael Yavilevich

### FIELD OF THE INVENTION

This invention relates generally to a reusable combined multistage aerospace system for repeatedly delivering a payload into an orbit around the earth or to midair, more particularly, to an aerial vehicle equipped with lift producing surfaces of sufficient capacity to permit the aerial vehicle to be pick up from one carrier aircraft by other tow aircraft in a midair and flight as glider behind the tow aircraft.

### BACKGROUND OF THE INVENTION

There are currently in use numerous methods for launch payloads to earth orbit. Several different types of launch vehicles are currently available for placing a spacecraft into orbit around the earth. These include launched under rocket power from a fixed launch pad. During the entire era of space flight air launch is seen as a very promising concept. Despite its claimed advantages, air launch is up till now only a marginal success of some companies. Air launch have numerous advantages over traditional vertical launch technology. There are several categories of air launch configurations.

Numerous vehicles have been designed within these groups, although not all are feasible with current technology. An analysis of mass savings shows that air launch systems can significantly reduce required liftoff mass as compared to vertical launch systems. Air launches typically involve two vehicles: a winged carrier aircraft and an upper stage launch vehicle. Depending on the mode of air launch, separation of the launch vehicle from the carrier can be dangerous, especially in cases of strong aerodynamic flow.

The towing glider technology to the launch vehicle is shown in U.S. Pat. No. 6,029,928, of inventor Michael Kelly. Other towing technology is shown in U.S. Pat. No. 9,944,410, of inventor Gerald Rudd. Prior art patents usually consist of two stages and do not reduce significant cost of satellite launch because a booster rocket separates from a carrier aircraft at low altitude and speed. To better realize the advantages of air launch of space vehicles, as well as reduce its cost, risks, and other limitations, a new approach is desired.

### SUMMARY OF THE INVENTION

The present invention overcomes the deficiencies of current aircraft launched technology through the application of combined launch technology. The combined launch system is a multistage technology of horizontal takeoff from a conventional runway and flight in atmosphere to launch payloads to orbit or midair. Combined launch method can consist of several stages. Multistage technology is more effective than prior art patents, since in every stage launch vehicle and spacecraft receive addition altitude and velocity by low cost. According to aspect of the invention the combined launch method includes a reusable or expendable spaceplane equipped with a ramjet engine and sustainer rocket engine. According to other aspect of the invention the combined launch method includes a reusable or expendable rocket plane equipped with a ramjet engine and coupled with a launch vehicle. A supersonic version of a ramjet, a scramjet engine may also be used under certain conditions. The ramjet or scramjet engine can accelerate the spaceplane and the rocket plane in upper atmosphere to a speed around 10-20 M.

In one aspect of the invention the reusable combined aerospace system for repeatedly launching payload to orbit comprises: a subsonic carrier aircraft, a supersonic tow aircraft, at least one orbital reusable spaceplane equipped with a ramjet or scramjet engine and a sustainer rocket engine and a spacecraft and/or another payload. The orbital spaceplane is used to place the spacecraft into earth orbit. The orbital spaceplane is equipped with aerodynamic lifting surfaces. The spaceplane is placed inside a fuselage or on external portions of the carrier aircraft with the aid of coupling unit. The carrier aircraft, coupled with the spaceplane, takes off horizontally and ascends to staging altitude and speed under carrier aircraft power with both the spaceplane and the carrier aircraft wings providing lift. After staging, the tow supersonic aircraft will pick up the spaceplane from the carrier aircraft in midair by using a tow line and a connecting assembly. The spaceplane may then be towed, using the flexible tow line, behind the tow aircraft. The carrier aircraft fly back for horizontal landing and the spaceplane continues ascending and accelerating by the supersonic tow aircraft.

The spaceplane in tow can be flown to any desired geographic location in the same manner as spaceplane carried outside or inside of a carrier aircraft. At proper altitude and speed, the ramjet propulsion system of the spaceplane started in a safe, stable manner, the spaceplane can be released from the tow line, and the spaceplane continue to ascend and accelerate in an atmosphere by using the ramjet engine. At the next stage the sustainer rocket engine ignites and delivers the spaceplane with the spacecraft into orbit. The spaceplane has a cargo bay with cargo bay doors. The spacecraft is deployed from the cargo bay by use of an ejection system. At proper altitude and speed the spaceplane eject the spacecraft from the cargo bay and propels the spacecraft into an orbit.

A reusable combined aerospace method for repeatedly launching payload to orbit comprising steps:
Before the flight, at least one spaceplane equipped with the sustainer rocket engine and the ramjet engine and the satellite arranged in a bay area, is installed inside or outside of the carrier aircraft.
The carrier aircraft, together with the spaceplane, takes off from a runway and fly to the meeting point with the tow aircraft, which is the supersonic aircraft.
At a given place, the tow aircraft extends the tow line with a connecting assembly, to which the spaceplane is attached in the flight and pick up the spaceplane from the carrier aircraft.
After the coupling of the spaceplane with the tow aircraft, the spaceplane is disconnected from the carrier aircraft and continues to fly under the influence of the lift created on its wing due to the thrust created by the engines of the tow aircraft.
The tow aircraft accelerates the spaceplane to supersonic speed to ensure the ignition of ramjet engines installed on the spaceplane.
After the ramjet engine is successfully turned on, the spaceplane is disconnected from the tow aircraft and continues to fly in the upper atmosphere.
After reaching the required speed of about 10-20 M, the sustainer rocket engine is ignited and accelerates the spaceplane with the spacecraft to orbital speed.
The spacecraft is ejected from the spaceplane and continues an orbital flight.
The spaceplane with the sustainer rocket engine and ramjet installed on it, is flying on the orbit and descend in the atmosphere and lands on the ground at suitable time.
After refueling the initial tow aircraft or other tow aircraft is ready to repeat the delivery of the remaining spaceplane from the carrier aircraft to orbit.

The advantage of the reusable system is the use of the spaceplane, equipped with the reusable sustainer rocket engine and the ramjet engine, will allow all elements of the system to be returned to earth for subsequent use.

In other aspect of the invention a partly reusable combined aerospace system for launching payload to orbit comprises: a subsonic carrier aircraft, a supersonic tow aircraft a suborbital rocket plane and a launch vehicle. The rocket plane equipped with a ramjet engine and coupled with a launch vehicle on launch site. The launch vehicle equipped with a sustainer rocket engine and detachably connected to the rocket plane. A spacecraft and/or other payload releasable connected to the launch vehicle. The rocket plane is placed inside a fuselage or on external portions of the carrier aircraft with the aid of coupling unit. The carrier aircraft, coupled with the rocket plane, takes off horizontally and ascends to staging altitude and speed under carrier aircraft power with both the rocket plane and the carrier aircraft wings providing lift. After staging, the tow supersonic aircraft will pick up the rocket plane coupled with the launch vehicle from the carrier aircraft in flight. The rocket plane may then be towed, using a flexible tow line, behind the tow aircraft. The carrier aircraft fly back for horizontal landing and the rocket plane continues ascending and accelerating by the supersonic tow aircraft.

The suborbital rocket plane is used to place the spacecraft into the earth orbit. The suborbital rocket plane is equipped with aerodynamic lifting surfaces, ramjet propulsion unit and detachable connected with launch vehicle equipped with sustainer rocket engine. The rocket plane coupling with the launch vehicle will disconnect from the supersonic tow aircraft and continue to ascend and accelerate in atmosphere by using ramjet engine. At the next stage the sustainer rocket engine of the launch vehicle ignites at proper velocity and altitude and the launch vehicle disconnect from the rocket plane. The launch vehicle delivers the spacecraft into orbit. The spacecraft is disconnecting from the launch vehicle by use of an ejection device.

The partly reusable concept involves the use of the suborbital rocket plane, detachably connected with the launch vehicle equipped with the sustainer rocket engine. The rocket plane itself and ramjet engines connected to the rocket plane can be expendable or reusable, depending on the space launch algorithm. In this embodiment, the rocket plane serves to accelerate the system in the atmosphere and will not be an orbital object.

A partly reusable combined aerospace method for repeatedly launching payload to orbit comprising steps of:
Before the flight, at least one rocket plane is coupled with the launch vehicle to whom is connected the satellite, is installed inside or outside the carrier aircraft.
The carrier aircraft, together with the rocket plane, takeoff from a conventional runway and fly to the meeting point with the tow aircraft, which is a supersonic aircraft.
At a given place, the tow aircraft stretched the tow line with a connecting assembly, to which the rocket plane is attached during the flight and pick up the rocket plane from the carrier aircraft.
After the coupling the rocket plane with the tow aircraft, the rocket plane is disconnected from the carrier aircraft and continues to fly under the influence of the lift created on its wing due to the thrust created by the engines of the tow aircraft.
The tow aircraft accelerates the coupled rocket plane to supersonic speed to ensure the ignition of ramjet engines installed on the rocket plane.
After the ramjet engine is properly turned on, the coupled rocket plane is disconnected from the tow aircraft and continues to fly in the upper atmosphere.
After reaching the required speed of about 10-20 M, the sustainer rocket engine on the launch vehicle is ignited and the launch vehicle disconnected from the rocket plane together with the satellite connected to launch vehicle.
The sustainer rocket engine accelerates the launch vehicle together with the satellite to orbital speed.
The satellite is disconnected from the launch vehicle and continues its orbital flight.
The rocket plane with the ramjet installed on it continues to descend in the atmosphere and lands on the ground.
The expendably launch vehicle with sustainer rocket engine fall down and burns up in the atmosphere.
After refueling the initial tow aircraft or other tow aircraft is ready to repeat the delivery of the remaining spaceplane from the carrier aircraft to orbit.

The advantage of the partly reusable system is to reduce the cost of design and preparation of production because vehicles of the second and third stages can be manufactured on the basis of existing models of rocket technology. However, on last stage the sustainer rocket engine does not produce addition energy required to accelerate the rocket plane to orbital velocity.

The length of the tow line used to tow the spaceplane or the rocket plane may be adjusted. The tow line is kept relatively short during pick up maneuver. The length of the line may be increased, (i.e., more line may be released from the tow aircraft) to maximize the distance between the tow aircraft and the towed vehicle prior to ignition the ramjet or scramjet engine of the spaceplane or the rocket plane. During towing, a distance between the towed vehicle and the tow aircraft can be varied using a winch mechanism.

The towed vehicle can also be positioned far enough behind the tow aircraft to permit ignition of the spaceplane propulsion system while the tow line is still connected, without endangering the crew of the tow aircraft. This provides enhanced reliability for the launch system since proper operation of the towed vehicle engine can be verified prior to irrevocable severing of the tow line. If the towed vehicle propulsion system fails to start properly, it can be shut down and the tow aircraft and the towed vehicle returned to the landing site safely.

A combined multistage method for instantly and repeatedly delivering a payload by air from a supplier to a wide variety of customers, comprising steps: a carrier aircraft, a piloted or unpiloted (UAV) tow aircraft, a towed glider and a payload loaded inside or outside of glider. Several gliders are placed inside or outside a fuselage of the carrier aircraft with the aid of supporting units. The carrier aircraft with loaded gliders takes off horizontally from a runway and ascends to a staging altitude. The tow aircraft equipped with at least one hook connected to a hard point of a fuselage and/or a wing of the aircraft. The winch mechanism equipped with flexible tow cable with a loop on the end of the tow cable arranged inside of the carrier aircraft. The glider removes from the carrier aircraft fuselage at identified place and time by means of a supporting assembly and the auxiliary tow line. The tow aircraft pick up in midair the glider, by using the hook engaged with the loop of the tow line of the glider. The powered drone or the piloted aircraft is used to tow the glider loaded with a different payload and deliver it to a proper place. The unpowered glider is used to discharge the emergency payload in midair to ground.

In other aspect the combined system for repeatedly delivering emergency payload in midair comprises: a carrier aircraft, a piloted or unpiloted (UAV) tow aircraft, a towed glider and a payload loaded inside or outside of glider. The glider equipped with a loop, or a hook connected to a forward portion of a fuselage. The tow aircraft equipped with a winch mechanism with a reel on which is a flexible tow cable is wound with a hook or a loop on the end of the tow cable. Several gliders are placed inside or outside a fuselage of the carrier aircraft with the aid of supporting units. The carrier aircraft with loaded inside gliders takes off horizontally from a runway and ascends to a staging altitude. The glider removes from the carrier aircraft fuselage at identified place and time by means of a supporting assembly and the auxiliary tow line. The tow aircraft pick up in midair the glider, by using the loop or hook of the glider engaged with the hook or loop of the tow line of the tow aircraft.

In one embodiment the combined system for repeatedly delivering flying payload in midair comprises: a carrier aircraft, a piloted or unpiloted (UAV) tow aircraft, and at least one towed flying payload. The flying payload equipped with aerodynamic lifting surfaces is arranged inside or outside of a fuselage of the carrier aircraft. The flying payload extends from the fuselage of the carrier aircraft at appropriate place by means of a support assemble and an auxiliary tow line. The tow aircraft or a drone pick up in midair the flying payload, by using the tow line and towing it to target area. In this embodiment a loop or a hook attached to the end of tow line and the hook or the loop in contrary arranged on flying payload.

A combined method of repeatedly and instantly delivering a payload by air comprising steps:
Loading several gliders and/or other winged payload inside or outside of the carrier aircraft.
Flying the carrier aircraft with gliders and/or winged payload to desired area.
Extending the glider or the winged payload from the carrier aircraft.
Pick up the glider or the winged payload by the tow aircraft or a drone from the carrier aircraft.
Turning the tow aircraft to cause the glider or the flying payload to follow the tow aircraft at the end of the tow line.
Delivering the glider or the payload to a determinate area by the tow aircraft or drone.
Releasing the glider or the payload from the tow line and landing in proper place.
Other tow aircraft or drone is ready to repeat the pick up and delivery of the remaining glider or the flying payload to consumers.

The advantage of the of the combined delivering method and the system is that small tow aircraft or drone can repeatedly pick up from the carrier aircraft and to tow the glider or the flying payload with a weight of which, with the load, significantly exceeds the possible carrying capacity of the towing vehicle itself.

The invention consists either of a spaceplane or rocket plane or glider airframe with suitable lifting surfaces have been appended and one or more propulsive stages incorporated into it. The spaceplane or the rocket plane or the glider can be completely expendable, partially reusable, or completely reusable depending on a specific vehicle requirement. It may be equipped with a landing gear to permit it to be landed on a ground. The spaceplane or the rocket plane or the glider are equipped with attachment points for connecting assembly and release mechanisms for coupling and decoupling with the tow line, and a control system which permits it fly either autonomously or under a remote control. Since the spaceplane or the rocket plane or the glider are equipped with wings which permit it to flight at aircraft speeds, it can clearly take off from the carrier aircraft under a power of the tow aircraft.

Ground handling before takeoff may be accomplished by mounting the spaceplane or the rocket plane or the glider outside of the carrier aircraft or loading at least one spaceplane or the rocket plane or the glider and/or other winged payload inside of the transport aircraft equipped with a cargo ramp or in other aircraft. The tow aircraft contributes only a thrust, not a lift, to the towed spaceplane or the rocket plane or the glider. Yet existing hard points on the tow aircraft are already capable of reacting of a drag force. An implication of the above is that far fewer structural modifications need to be made to the tow aircraft to enable it to tow a heavy load than to carry a light load on a pylons.

At the end of the flight, if the spaceplane is to be recovered, a high lift can work to reduce heat loading on the vehicle and extend its range. Once a propellant has been expended, the spaceplane wing loading is so low compared to its takeoff value that heating and maneuvering loads are much more benign than would be possible with a low lift vehicle. The spaceplane equipped with a landing gear will fly back to the earth for horizontal landing. Combined launch system may also have a parachute drop recovery system to recover the spaceplane or the rocket plane or glider or drone after it descend.

The combined system may also have a fuel transfer assembly for pumping a fuel from the tow aircraft to the towed spaceplane or the glider and in opposite direction from the towed glider to the tow aircraft or other aircraft. In this embodiment the tow line may consists of a fuel pipeline. This method also provides using the towed glider like a winged external auxiliary fuel tank.

The carrier aircraft, the tow aircraft and the spaceplane or rocket plane or glider may be equipped with a rotating winch assembly with a reel, were wound the tow line before and after towing. The spaceplane or the rocket plane or a glider and the launch vehicle and the spacecraft is being remotely controlled from the ground and/or the carrier aircraft and the tow aircraft during all stages of a flight.

The combined multi stages aspect intrinsic to the invention sets it apart from all other air launched or aerodynamically assisted concepts. It operates in a different flight regime than two stages methods. There are also numerous practical benefits which accrue from the combined launch system, such as the above-mentioned simplification of aircraft modifications.

The combined launch method of utilizing the lift of spaceplane wings to fully offset its weight permits to increase in the weight of spacecraft which can be launched compared to prior art launch methods. The combined launch method also requires fewer and simpler modifications to a conventional aircraft than do any other current or proposed air launch methods. The proposed system makes it possible to enhance a payload capacity and to reduce the specific cost of putting a payload in an orbit, to provide a high degree of safety for the carrier aircraft and its crew, and to ensure ecological safety of the system.

From the perspective of the spaceplane, being towed relieves it of the need to carry heavy propulsion systems or a fuel to carry it from the runway to the point of powered flight ascent. This simplifies the spaceplane, and effectively transfers the burden of getting from the takeoff point to the point of powered ascent initiation to the tow aircraft in the same manner as the spaceplane carried aboard on the carrier aircraft. The spaceplane can climb at a shallower angle for a longer period since it is supported entirely aerodynamically.

During ascent, the ramjet or scramjet engine powered the suborbital rocket plane does not achieve sufficient velocity within the sensible atmosphere to make an aerodynamic heating an intractable problem. Reentry heating is significantly less for this rocket plane than that experienced by a vehicle entering the atmosphere from an orbit, for two reasons. The first is that the maximum velocity of this stage does not exceed of that required to achieve the orbit. Heating loads may thus be accommodated by application of simple, durable insulation materials over most of the structure, and refractory materials in stagnation regions.

Use of expendable upper stages simplifies the development of the vehicle in this embodiment in other respects. By placing half of the propulsive burden on engines which are commercially available, it requires no extensive development of upper stages. More importantly, however, it simplifies the task of protecting the recoverable stage from aerodynamic heating during ascent and, especially, during reentry.

This is the preferred embodiment for initial development because it represents the most cost-effective solution in terms of initial and operational cost. Commercially available expendable upper stages may be used, requiring no development cost. The recoverable suborbital rocket plane is readily developed using existing airframe and propulsion technologies. Guidance and navigation systems are commercially available for controlling the vehicle through all flight regimes, including automated landing of the first stage and orbital injection of the satellite stage.

Overall, these embodiments represent the best balance of development cost and risk and operational cost and risk of any near-term system whose primary objective is to minimize cost and risk. Other implementations are possible, employing other types of propulsion systems, including air breathing systems in the spaceplane and the rocket plane and recoverable upper stages. These embodiments described herein is preferred mainly because it does not tax the state of the art in aircraft or launch vehicles, but combines elements of both in a simple fashion which nonetheless results in a significant advance in the state of the art.

### BRIEF DESCRIPTION OF THE DRAWINGS

FIGS. 1A-1B show a carrier aircraft, a tow aircraft, and a spaceplane or a rocket plane.

FIGS. 2A-2B show a carrier aircraft, a tow aircraft, and a glider.

FIG. 3 shows a supersonic aircraft towing a rocket plane.

FIG. 4 shows a tow aircraft towing 3 gliders.

### DETAILED DESCRIPTION

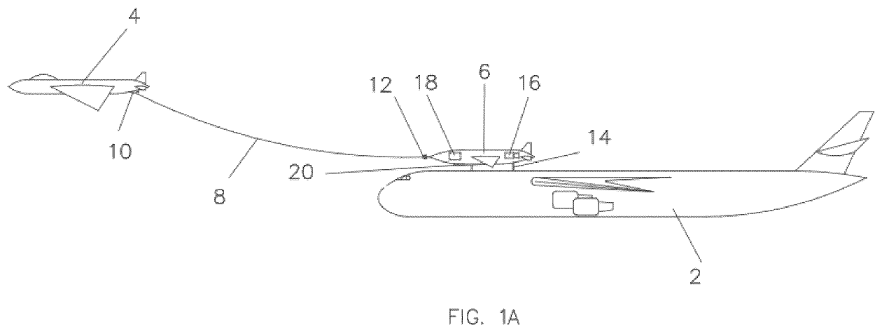

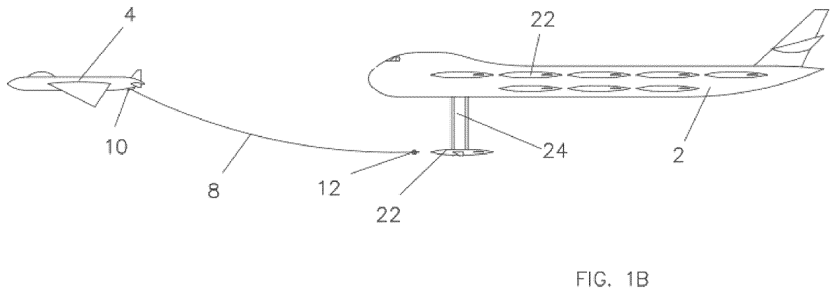

FIG. 1A shows one embodiment of the combined aerospace system for delivering a spacecraft to the orbit, comprises a subsonic carrier aircraft 2, a supersonic tow aircraft 4 and a spaceplane 6. FIG. 1A illustrates one possible implementation of a means of pick up in midair the spaceplane 6, loaded on top of the carrier aircraft 2 by the tow aircraft 4 in flight. The aircraft 4 flight ahead of coupling the carrier aircraft 2 and the spaceplane 6. The aircraft 4 deploys a tow line 8 from a reel assembly 10, arranged on the aircraft 4. An end of the tow line 8 contains a connecting assembly 12 to connect the aircraft 4 with the spaceplane 6. The spaceplane 6 is placed on a top of a fuselage of the carrier aircraft 2 with the aid of a coupling unit 14. After locking the connecting assembly 12, the coupling unit 14 on carrier aircraft 2 is open and the aircraft 4 pull the spaceplane 6 up and forward in midair. The spaceplane 6 equipped with a sustainer rocket engine 16, and a bay area where a spacecraft 18 arranged, and a ramjet engine 20 is an integral part of the spaceplane 6.

FIG. 1B shows other embodiment of the combined aerospace system for delivering spacecrafts to an orbit, comprises a subsonic carrier aircraft 2, a supersonic tow aircraft 4, and several rocket planes 22 placed inside of a fuselage of the carrier aircraft 2. FIG. 1B illustrates one possible implementation of a means of pick up in midair the rocket plane 22, loaded inside of the carrier aircraft 2 by the tow aircraft 4 in flight. One rocket plane 22 extends from a fuselage of the carrier aircraft 2 by aid of a supporting assembly 24. The aircraft 4 flight ahead of the carrier aircraft 2. The aircraft 4 deploys the tow line 8 from the reel assembly 10, arranged on a tail of aircraft 4. The end of the tow line 8 consists of a connecting assembly 12 to connect the aircraft 4 with the rocket plane 22. After locking the connecting assembly 12, the supporting assembly 24 on the carrier aircraft 2 open and the aircraft 4 pull the rocket plane 22 forward in midair.

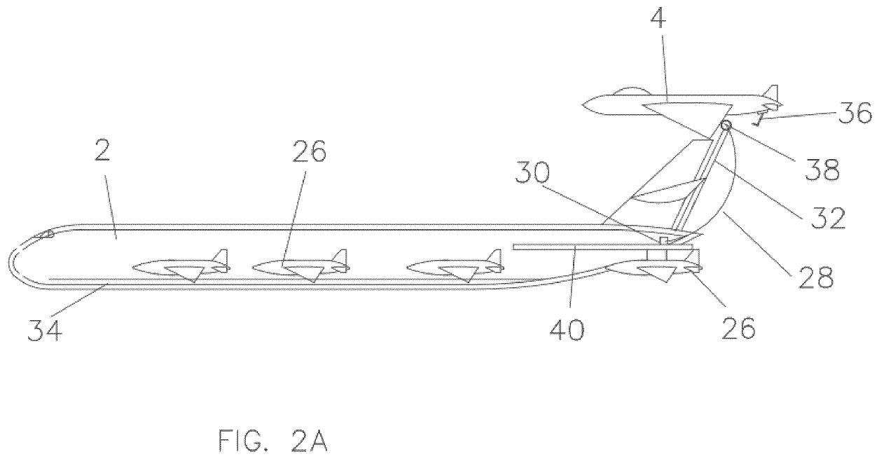

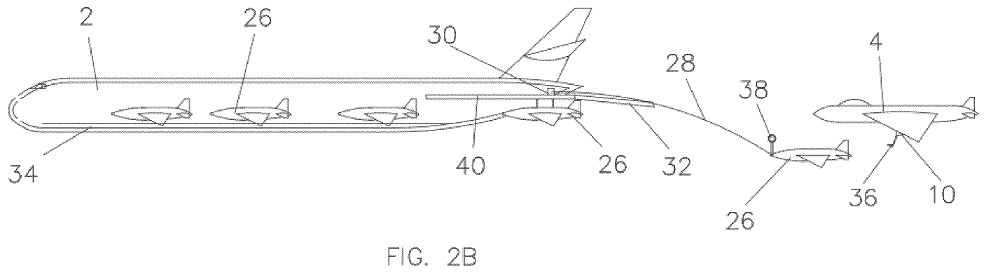

FIG. 2A shows other embodiment of the system for delivering payload to customers, comprises a carrier aircraft 2, a tow aircraft 4 and a several gliders 26 arranged inside the carrier aircraft 2. The aircraft 2 have a cargo compartment and a rear end opening for a cargo dispatch in midair. FIG. 2A illustrate one possible implementation of a means of pickup in midair the glider 26, loaded inside of the carrier aircraft 2 by the tow aircraft 4 in flight. The aircraft 4 flight above of the carrier aircraft 2. The aircraft 2 deploys an auxiliary tow line 28 from a winch assembly 30, arranged inside of cargo compartment of the aircraft 2, and a foldable mast 32. Gliders 26 connects to the aircraft 2 by sway braces movable on supporting rails 34. The tow aircraft 4 equipped with a hook 36 connected to hard points of airframe on fuselage and/or wing of the aircraft 4. One end of the tow line 28 consist of a loop 38 to connect the aircraft 4 with the glider 26. Other end of the tow line 28 connected with a locking device of the glider 26. Before picking up the glider 26 is hinged on a supporting assembly 40 and removes from a rear end opening of the aircraft 2 by means of the supporting assembly 40 and the auxiliary tow line 28. After the hook 36 catch up the loop 38 the aircraft 4 pulls the glider 26 in opposite direction to the aircraft 2. The glider 26 in tow can then be flown to any desired geographic location. At staging place, the glider 26 disconnects from the tow line and arrives to the customer receiving port.

FIG. 2B shows next embodiment of the system for delivering payload to customers, comprises a subsonic carrier aircraft 2, a tow aircraft 4, a several gliders 26 arranged inside the carrier aircraft 2. Gliders 26 connect to the aircraft 2 by sway braces movable on supporting rails 34. The aircraft 2 have cargo compartment and opening on rear part of the aircraft fuselage to extend the glider 26 in midair. FIG. 2B illustrate similar possible implementation, when one glider 26 is loaded on supporting assembly 40 and other glider 26 is towing behind the carrier aircraft 2 by aid of auxiliary tow line 28. Tow aircraft 4 flight behind the carrier aircraft 2. The tow aircraft 4 equipped with a winch mechanism with a reel 10 on which a flexible tow cable is wound with a hook 36 on the end of the tow cable. The glider 26 equipped with a loop 38 connected with a nose portion of the glider 26. Before picking up the glider 26 is arranged on a supporting assembly 40 and connected with winch mechanism by an auxiliary tow line 28. The glider 26 removes from the carrier aircraft 2 at identified place and time by aid of the supporting assembly 40 and a folding mast 32. After releasing from the supporting assembly 40 the glider 26 begins to flight in towing manner by aid of the auxiliary tow line 28. The winch mechanism 30 extends tow line 28 in bigger distance to allow the aircraft 4 to flight in a vicinity to towing glider 26. The aircraft 4 deploys the hook 36 from a reel assembly 10. After the hook 36 catch the loop 38, the glider 26 disconnects from the auxiliary tow line 28 and the aircraft 4 pulls the glider 26 away from the carrier aircraft 2. A next tow aircraft could repeat the pickup of the remaining gliders from the carrier aircraft. The glider 26 in tow can then be flown to any desired geographic location. At staging place, the glider 26 disconnects from the tow line and arrives to the customer receiving port.

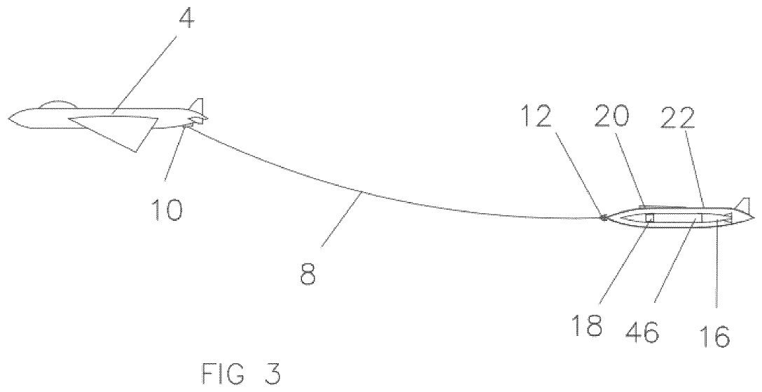

FIG. 3 show the supersonic aircraft 4 towing the rocket plane 22. The rocket plane 22 coupled with a launch vehicle 46. The launch vehicle 46 is equipped with the sustainer rocket engine 16. The spacecraft 18 detachable connected with the launch vehicle 46. At certain speed and attitude, the rocket plane 22 started ramjet engine 20 in a safe, stable manner, and the tow line 8 can be released, and the rocket plane 22 continue to ascend and accelerate in atmosphere by using ramjet engine 20. At next step the sustainer rocket engine 16 on the launch vehicle 46 ignited and the launch vehicle 46 and spacecraft 18 disconnect from the rocket plane 22. The launch vehicle 46 is used to place the spacecraft 18 into earth orbit.

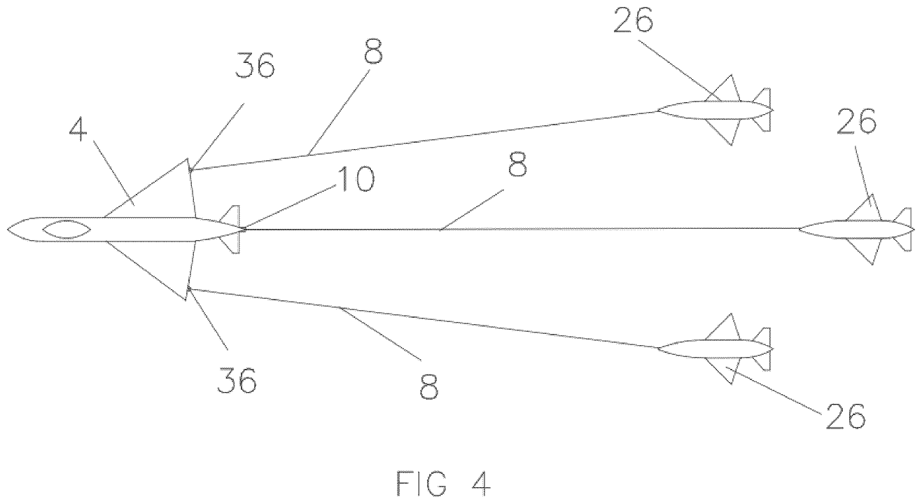

FIG. 4 show an aircraft 4 towing three gliders 26 with a payload. One glider 26 connected by the tow line 8 to a reel assembly 10 mounted on a tail of the aircraft 4. Two gliders 26 connected by two tow lines 8 to the hooks 36 mounted on a wing of the aircraft 4.

What is described herein are specific examples of many possible variations on the same invention and are not intended in a limiting sense. The claimed invention can be practiced using other variations not specifically described above.

### INDUSTRIAL APPLICABILITY

The present invention may be realized with the use of a currently available aircraft. Using currently available rocket engines, as well as a sustainer and booster rockets produced by well-developed manufacturing technologies, make it possible to create a launch vehicle for the proposed aerospace system in the shortest possible time and at minimum cost. The coupling and ejection unit of the proposed design is made in accordance with known technologies and with the use of, among other things, off-the-shelf component parts.

What is claimed is:

1. A reusable combined multistage aerospace system for repeatedly delivering payload to an orbital or suborbital trajectory and to midair comprises: a subsonic carrier aircraft, at least one supersonic tow aircraft, at least one towed aerial vehicle, at least one ramjet or scramjet engine, at least one sustainer rocket engine and/or launch vehicle; at least one spacecraft or another payload, wherein the subsonic carrier aircraft is intended to take off, to lift and to accelerate the aerial vehicle to a certain height and speed; and the tow aircraft is intended to pic up the aerial vehicle from the carrier aircraft in midair by using tow line; and the ramjet or scramjet engine is intended to accelerate the aerial vehicle in atmosphere; and the rocket engine and/or launch vehicle is intended to accelerate the aerial vehicle and the payload in orbital or suborbital trajectory or in midair.

2. The aerospace system of claim 1, wherein the carrier aircraft is adapted to arrange at least one aerial vehicle inside of a fuselage or outside of the aircraft, with the aid of coupling units, and take off from a runway for horizontal flight, and the carrier aircraft has doors and means to extend the aerial vehicle from the fuselage.

3. The aerospace system of claim 1, wherein the tow aircraft is adapted to pick up the aerial vehicle from the carrier aircraft, in midair, by means of a flexible tow line, and is intended to accelerate the towed aerial vehicle to supersonic speed in order to turn on the ramjet or scramjet engine, arranged on this towed aerial vehicle; the tow aircraft equipped with a winch mechanism and the tow line with a connecting assembly to connect with a connecting device of the towed aerial vehicle.

4. The aerospace system of claim 1, wherein the aerial vehicle is a reusable orbital spaceplane or rocket plane or glider or flying payload and releasable arranged inside of a fuselage or outside of the carrier aircraft, before takeoff, with the aid of coupling units.

5. The aerospace system of claim 4, wherein the aerial vehicle is equipped with lift producing surfaces, providing a flight in an atmosphere, and adapted to takeoff from the carrier aircraft in midair, by aid of the tow aircraft, and reaching supersonic velocity, while being towed by the tow aircraft to a required altitude and a velocity.

6. The aerospace system of claim 4, wherein the towed aerial vehicle is equipped with at least one ramjet or scramjet engine for increasing velocity and an altitude in atmosphere after disconnecting from the tow aircraft.

7. The aerospace system of claim 4, wherein the spaceplane is equipped with at least one sustainer rocket engine, the engine intends to accelerate the spaceplane and the spacecraft to required velocity and altitude.

8. The aerospace system of claim 4, wherein the aerial vehicle is equipped with a bay area for arranging the payload and delivering it in orbit or in midair.

9. The aerospace system of claim 4, wherein the aerial vehicle is equipped with an injecting device for deploying the payload arranged inside the bay area after reaching a required altitude and a velocity.

10. The aerospace system of claim 4, wherein the aerial vehicle is equipped with a connecting device to connect with the tow line connecting assembly during pick up by the tow aircraft in a midair.

11. (canceled)

12. (canceled)

13. (canceled)

14. (canceled)

15. (canceled)

16. (canceled)

17. (canceled)

18. The aerospace system of claim 4, wherein the rocket plane is detachable coupled with the launch vehicle, the launch vehicle is equipped with the rocket engine, the engine intends to accelerate the launch vehicle and the space craft of other payload to required velocity and altitude, the launch vehicle intends for delivering the spacecraft to an orbit and is equipped with an injecting device for deploying the spacecraft.

19. (canceled)

20. (canceled)

21. A reusable combined multistage aerospace method for repeatedly delivering the payload to an orbital or suborbital trajectory and to midair comprising steps: providing a carrier aircraft, at least one tow aircraft, at least one aerial vehicle and at least one spacecraft or another payload; arranging at least one spacecraft or another payload inside the bay area of the aerial vehicle; releasable arranging at least one aerial vehicle inside of a fuselage or outside of the carrier aircraft; accelerating the carrier aircraft coupled with aerial vehicle to takeoff on a runway; maintaining a flight of the coupling carrier aircraft and the aerial vehicle to a required location; flying the tow aircraft to the required location in a vicinity of the coupling carrier aircraft and the aerial vehicle ; flying the carrier aircraft to cause the aerial vehicle to follow a further path of the tow aircraft; extending the aerial vehicle thru an aperture of a fuselage of the carrier aircraft at identified place and time by means of the supporting assembly and an auxiliary tow line; pick up the aerial vehicle by the tow aircraft from the carrier aircraft by aid of tow line in a midair; turning the tow aircraft to cause the aerial vehicle to follow the tow aircraft while being connected to the tow line; increasing the length of the tow line; providing the aerial vehicle to be towing in atmosphere after takeoff from the carrier aircraft under a power of the tow aircraft; accelerating the tow aircraft with towed aerial vehicle to required location and velocity to provide optimal trajectory for the payload delivery; starting the ramjet propulsion system of the aerial vehicle; releasing the aerial vehicle from the tow aircraft; controlling the aerial vehicle for climb to a predetermined altitude and velocity; starting the propulsion system of the sustainer rocket engine of the aerial vehicle; controlling the aerial vehicle for climb to a predetermined altitude and velocity; deploying the spacecraft or another payload from the bay area of the aerial vehicle to an orbit or midair; preparing the initial tow aircraft or another tow aircraft to repeat the pick up of remaining aerial vehicle from the carrier aircraft and delivery a next payload; returning the carrier aircraft, the tow aircraft and the reusable aerial vehicle and the reusable ramjet and the sustainer engine to the launch site.

22. The method as defined in claim 21, in which the step of delivering the payload is performed by the reusable spaceplane equipped with the ramjet or scramjet engine and the sustainer rocket engine.

23. The method as defined in claim 21, in which the step of delivering the payload is performed by the partly reusable rocket plane equipped with the ramjet or scramjet engine and detachably connected with the expendable launch vehicle.

24. The method as defined in claim 21, in which the step of delivering the payload is performed by the glider, wherein the glider may be correspondingly a powered drone or a flying winged payload or an auxiliary winged fuel tank, equipped with lift producing surfaces for flight in an atmosphere.

25. (canceled)

26. (canceled)

27. (canceled)

28. The method as defined in claim 24, wherein the glider is equipped with a bay area, for arranging a payload and delivering it to a required area and the glider arrives at the customer's receiving port, after being released from the towing aircraft.

29. The method as defined in claim 24, wherein the glider equipped with an auxiliary motor, to return to carrier aircraft or to runway for landing.

30. The method as defined in claim 24, wherein the coupling assembly and the coupling device contain a hook and loop, respectively connected with the tow aircraft and/or the towed glider.

31. (canceled)

32. (canceled)

33. (canceled)

34. (canceled)
